(19) United States
(12) Patent Application Publication
(10) Pub. No.: US 2013/0290898 A1
(43) Pub. Date: Oct. 31, 2013

(54) METHOD FOR PRESENTING PROMPT MESSAGE, TERMINAL AND SERVER

(71) Applicants: Youlong Lu, Bejing (CN); Tianshu Wang, Beijing (CN)

(72) Inventors: Youlong Lu, Bejing (CN); Tianshu Wang, Beijing (CN)

(73) Assignees: Beijing Lenovo Software Ltd., Beijing (CN); Lenovo (Beijing) Limited, Beijing (CN)

(21) Appl. No.: 13/978,667

(22) PCT Filed: Jan. 6, 2012
(86) PCT No.: PCT/CN12/70089

§ 371 Date: Jul. 8, 2013

(30) Foreign Application Priority Data
Jan. 12, 2011 (CN) 20111006092.0

(51) Int. Cl. G06F 3/0481

(52) U.S. Cl. CPC G06F 3/0481
USPC 715/808

(57) ABSTRACT

The present invention provides a method for presenting a prompt message, a terminal and a server. The method includes: monitoring a current state of the terminal; obtaining state description information for the current state when the current state satisfies a predetermined condition; obtaining address information for a set of applications; obtaining a search result by searching the set of applications corresponding to the address information for an application corresponding to the current state based on the state description information; and presenting a prompt message indicative of the search result in the terminal. With the embodiments of the present invention, a user's operation scenario and use state are automatically captured and the application associated with the current use scenario is automatically recommended, as a solution, from various categories in an application store based on requirements of the scenario, such that the user can directly acquire the application. In this way, the user can access software applications that can exactly satisfy his/her requirements in a more quickly manner.

### TECHNICAL FIELD

The present invention relates to communication technology, and more particularly, to methods for presenting a prompt message, terminals and servers.

### BACKGROUND

In an application store, or app store, there are a large number of software applications. The software applications in an app store are categorized such that a user can search for an application conveniently. In this way, the user can search for a software application according to its category.

However, categories in an app store are very general, and each contain so many software applications that a user has to spend a long time on searching in order to find an application he or she needs. Further, currently the software applications are updated frequently. Thus, in many cases, the function of a current version of a user's software application cannot satisfy his/her current requirement. For example, without timely updating, some software applications installed in a user terminal may not provide expected functions, or even may not function properly. In this case, the user has to manually search the software applications (which may be application programs or updated components thereof). However, even if the user can find these software applications, he/she is unaware of their details and thus cannot determine whether they can solve his/her current problem. In this case, the user cannot determine whether to download and install the applications or not. This affects the use of the terminal and degrades the user experience.

That is, in the prior art, it is for a user to take a long time to search a software application manually. Further, the user cannot determine whether the found software application can solve the problem that occurs in his/her use of the terminal, and thus cannot determine whether to download and install it. This degrades the user experience. Currently there is no effective solution to such problem.

### SUMMARY

The embodiments of the present invention provide a method for presenting a prompt message, a terminal and a server, capable of facilitating user operation and improving user experience.

According to an aspect of the present invention, a method for presenting a prompt message in a terminal is provided. The method includes: monitoring a current state of the terminal; obtaining state description information for the current state when the current state satisfies a predetermined condition; obtaining address information for a set of applications; obtaining a search result by searching the set of applications corresponding to the address information for an application corresponding to the current state based on the state description information; and presenting a prompt message indicative of the search result in the terminal.

In an embodiment, the current state includes one of a current operation state of an operating system of the terminal, and a current state of an application running in the terminal.

In an embodiment, that the current state satisfies the predetermined condition may refer to one of: a state change incurring pop-up of a prompt message occurs in the operating system, a detectable state change not incurring pop-up of a prompt message occurs in the operating system, a state change incurring pop-up of a prompt message occurs in an application running in the terminal, and a detectable state change occurs in an application running in the terminal.

In an embodiment, the address information for the set of applications includes at least one of an address of the set of the applications in a memory unit of the terminal, and an address of the set of applications in a server connected with the terminal.

In an embodiment, the address of the set of applications in the server connected with the terminal includes an address of the set of applications in an application store connected with the terminal.

According to another aspect of the present invention, a terminal is provided. The terminal includes: a monitoring module configured to monitor a current state of the terminal; a first obtaining module configured to obtain state description information for the current state when the current state satisfies a predetermined condition; a second obtaining module configured to obtain address information for a set of applications; a third obtaining module configured to obtain a search result by searching the set of applications corresponding to the address information for an application corresponding to the current state based on the state description information; and a prompting module configured to present a prompt message to indicative of the search result in the terminal.

In an embodiment, the current state includes one of a current operation state of an operating system of the terminal, and a current state of an application running in the terminal.

In an embodiment, that the current state satisfies the predetermined condition may refer to one of a state change incurring pop-up of a prompt message occurs in the operating system, a detectable state change not incurring pop-up of a prompt message occurs in the operating system, a state change incurring pop-up of a prompt message occurs in an application running in the terminal, and a detectable state change occurs in an application running in the terminal.

In an embodiment, the terminal further includes a memory module configured to store the set of applications.

In an embodiment, the terminal further includes a search module configured to search the set of applications in the memory module for the application corresponding to the current state based on the state description information, thereby determining the search result.

In an embodiment, the terminal further includes a communication module configured to send the state description information to a server connected with the terminal and receive the search result from the server. The set of applications is stored in the server, and the server is configured to search the set of applications for the application corresponding to the current state based on the state description information, thereby determining the search result.

According to yet another aspect of the present invention, a server is provided. The server includes: a receiving module configured to receive state description information from a terminal, the state description information corresponding to a current state of the terminal, and being obtained when the current state is monitored to be satisfy a predetermined condition; an obtaining module configured to obtain a search result by searching for an application corresponding to the current state based on the state description information; and a transmitting module configured to send the search result to the terminal such that the terminal presents a prompt message indicative of the search result.

According to the present invention, a user's operation scenario and use state are automatically captured, and an application associated with the current use scenario is automatically recommended, as a solution, from various categories in an application store based on requirements of the scenario, such that the user can directly acquire the application. In this way, the user may access more quickly any software application that can exactly satisfy his/her requirements. With the present invention, the user can search a large number of software applications in an app store for a desired application quickly and accurately, thereby solving the problem in the prior art that the user has to spend a long time on searching a software application manually, and cannot determine whether the found software application can solve the problem that occurs in use of the terminal.

### BRIEF DESCRIPTION OF THE DRAWINGS

FIG. 1 is a flowchart illustrating a method according to an embodiment of the present invention;

FIG. 2 is a block diagram showing the structure of a terminal according to an embodiment of the present invention; and

FIG. 3 is a block diagram showing the structure of a server according to an embodiment of the present invention.

### DETAILED DESCRIPTION OF THE EMBODIMENTS

The solutions of the present invention will be described in detail with reference to the figures and the embodiments, such that the objects, features and effects of the present invention will be more apparent.

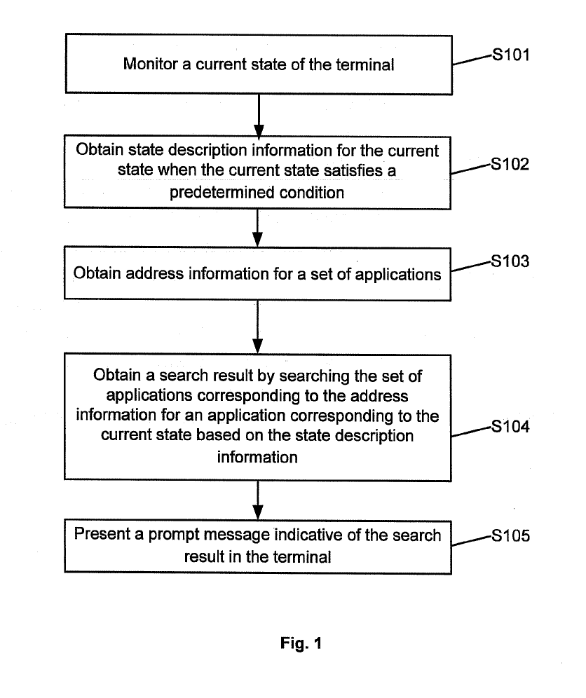

FIG. 1 is a flowchart illustrating a method for presenting a search result to a user according to an embodiment of the present invention. The method may be applied in a terminal, such as a mobile phone, a personal computer or the like. As shown in FIG. 1, the method includes the following steps.

At step S101, a current state of the terminal is monitored. Here, the current state includes one of a current operation state of an operating system of the terminal, and a current state of an application running in the terminal.

At step S102, when the current state satisfies a predetermined condition, state description information for the current state is obtained. Here, the current state satisfying the predetermined condition may refers to one of: a state change incurring pop-up of a prompt message occurring in the operating system, a detectable state change not incurring pop-up of a prompt occurring in the operating system, a state change incurring pop-up of a prompt message occurring in an application running in the terminal, and a detectable state change occurring in an application running in the terminal.

At step S103, address information for a set of applications is obtained. Here, the address information for the set of applications includes at least one of an address of the set of the applications in a memory unit of the terminal, and an address of the set of applications in a server connected with the terminal. In particular, the address of the set of applications in the server connected with the terminal includes an address of the set of applications in an application store connected with the terminal.

At step S104, a search result is obtained by searching the set of applications corresponding to the address information for an application corresponding to the current state based on the state description information. Here, the search result may indicate that one or more applications corresponding to the current state have been found, or that no application corresponding to the current state is found.

At step S105, a prompt message indicative of the search result is presented in the terminal.

For example, when a message popped up in the terminal indicates that a document format cannot be processed, a memory unit of the terminal may be searched for an application associated with the document format. If such application is found, the suffix of the document format may be presented to the user in the terminal (e.g., in a case of a text document, the suffix can be “.txt”, “.doc” or “.docx”). Likewise, a server connected to the terminal may be searched for an application associated with the document format. If such application is found, the suffix of the document format may be presented to the user in the terminal. When a message popped up in the terminal indicates that the language of a content to be displayed is inconsistent with the language in system configuration, a memory unit of the terminal may be searched for an application associated with the language of the content. If such language application is found, an identification of the language type of the content may be presented to the user in the terminal (e.g., an identification of “EN” can be used for the English language and an identification of “CN” can be used for the Chinese language). Likewise, a server connected to the terminal may be searched for an application associated with the language of the content to be displayed. If such application is found, an identification of the language type of the content may be presented to the user in the terminal.

Each application in the set of applications generally has a label and/or keyword and/or description information. Accordingly, during searching the set of applications corresponding to the address information for the application corresponding to the current state based on the state description information, search for the application may be performed by using the state description information as a keyword. Alternatively, a keyword may be further extracted from the state description information, and the application may be searched for based on the extracted keyword.

When presenting the prompt message indicative of the search result in the terminal, if the search result indicates that one or more applications corresponding to the current state have been found, prompt information indicating that the set of applications contains the application corresponding to the current state may be displayed in the terminal. When the user clicks the prompt information, the search result (e.g., a link to the found application) will be displayed. If the search result indicates that no corresponding application is found, prompt information indicating that the set of applications contains no application corresponding to the current state may be displayed in the terminal, for example, a message “Corresponding Application Not Found” being displayed in the terminal.

In addition, when displaying the search result in the terminal, if the search result indicates that “a small number” of local applications are found (where the set of applications is provided in the memory unit of the terminal), portals or shortcuts to the found applications may be displayed directly in the terminal. In this case, the user may launch the applications by triggering the portals or shortcuts. If the search results indicates that “a small number” of server applications are found (where the set of applications is provided in a server connected with the terminal), application introductions and download prompts (e.g., buttons for download prompts) may be displayed in the terminal. In this case, the user may download and install the applications by triggering the download prompts. When the search result indicates that “a large number” of applications are found (either local applications or server applications), a part of these applications may be displayed in the terminal in accordance with a predetermined policy. Here, the predetermined policy may be based on one of an evaluation score of an application, the number of times an application has been downloaded, the number of times an application has been recommended, or whether an application is free. For example, when the search result indicates that 10 applications are found, these applications may be ordered in a descending order of the number of times each application has been downloaded and, when displaying the applications in the terminal, the first five applications may be first presented to the user.

Further, if the set of applications is available from an app store connected with the terminal, the terminal may log into the app store using prestored user name and password to acquire the applications. Alternatively, if the user has logged into the app store and maintains his/her login state, the user may obtain the applications directly. A background program of the terminal detects the state of the terminal in real time. The state to be detected may include: a warning pop-up during operation, for example, indicating that a website is inaccessible, a content requires support of a particular language package or a plug-in, there is no sufficient space in memory/cache/ROM/RAM of the terminal, there is no sufficient power supply, a wrong password is input, or a function is not supported by the current version; a state of an application or a content itself, for example, indicating that a new version is detected, content update is required, or a trial term has expired; a browsing state of a browser, for example, indicating a currently browsed website, a redirected-to website, or a commonly-browsed website; or an input keyword, for example, a keyword for performing a search, a commonly-used tag; or reception of another command related to state detection from a specific API.

Optionally, there are a number of situations in which the current state of the terminal may satisfy the predetermined condition. Various factors, such as operating system of the terminal, application in the terminal, network used by the terminal and user operation, may cause the current state to satisfy the predetermined condition. For example, a warning pop-up during user operation (e.g., a warning indicating that a website is inaccessible, website content requires support of a particular language package or a plug-in, no sufficient space exists in memory/cache/ROM/RAM of the terminal, there is no sufficient power supply, a wrong password is inputted by the user, a function cannot supported by the current version of a certain application in the terminal, a new version of an application is currently available, some content in the terminal requires to be updated, or trial term of an application has expired), a browsing state of a browser (e.g., currently browsed website, redirected-to website, or a commonly-used website), a user-inputted keyword (e.g., user-inputted search keyword, a commonly-used tag), or reception of another command related to state detection by the terminal from a specific API may trigger the processing of the above step S102.

Further, although the operating system of the terminal, network, application, user operation or external instruction may cause the above state to occur and to be detected by the background program, the state caused by the network factor may be actually reflected in the operating system. Also, the state caused by an application or a user operation may be actually reflected in the operating system, and the state caused by the operating system may be reflected in an application. That is, for an occurrence of a state, the operating system of the terminal, network, application, user operation, external instruction and the like may be cause and effect with respect to each other. Further examples of such situations will be omitted here.

Further, the server of an app store may categorize all its applications based on the state of the terminal and link them to the state so as to create a state solution library. The list and order of the applications corresponding to each state may be dynamically updated and adjusted. In particular, the correspondences between the is states and the applications may be established based on one or more of: initial coarse categories of the applications, categories and tags added by other users, related applications recommended by other users, tags and categories added at the server, and refined categories and tags provided to application developers via APIs.

In the terminal, a link to the app store presented to the user may be one of: a Banner, a dialog box, an interface redirected to by using a specific prompt button, information presented in a system information prompt bar, and other possible specific interfaces.

According to the embodiments of the present invention, a user's operation scenario and use state are automatically captured by the operating system of the terminal and the application associated with the current use scenario is automatically recommended, as a solution, from various categories in an application store based on requirements of the scenario, such that the user can directly acquire the application. In this way, the user may access software applications that can exactly satisfy his/her requirements in a more quickly manner. With the present invention, the user can search a large number of software applications in an app store for a desired application quickly and accurately, thereby solving the problem in the prior art that the user has to spend a long time on searching a software application manually and cannot determine whether the found software application can solve the problem that occurs in use of the terminal.

The embodiments of the present invention will be explained in the following in conjunction with particular examples.

### Example 1

The current system state of the terminal is monitored. When the user opens a pdf file, if there is currently no software application that can open a pdf file in the terminal, the operating system will pop up a prompt message indicating that the file cannot be opened at the moment. The operating system intercepts this prompt message and obtains a current state that a pdf file cannot be opened. The operating system obtains keywords “pdf” and “display”, obtains the user's user name and password registered with an app store and logs into the app store to search for an application by using “pdf+display” as keywords. The terminal obtains a software application named XXX and maintains the login state to the app store. It is to be noted here that, although a process of logging into an app store to search for an application has been described, in practice, the user may either search for an application after a successful login, or log in and download an application after a search is completed.

Next, the system pops up the above prompt that the pdf file cannot be opened, and then the terminal pops up a prompt message indicating that there is a software application capable of opening a pdf file in the app store. Alternatively, the system may intercept the above prompt message that the pdf file cannot be opened, and modify the prompt message to directly display the prompt message together with the search result.

The user views the above prompt message, and can directly access the webpage for the software application XXX in the app store. Since the user has logged into the app store, he/she can now download and install the software application XXX.

Alternatively, if the user does not view the webpage for the software application XXX in the app store, he/she can log out from the app store.

### Example 2

The current application state of the terminal is monitored. When the user views a pdf file and tries to edit it, if the current software application XXX does not support edition of a pdf file, the software application XXX will pop up a prompt message indicating that the file cannot be edited. The system (e.g., a background program in the system, or another program independent of the system) intercepts this prompt message, and obtains a current state that a pdf file cannot be edited. The system obtains keywords “pdf” and “edit”, obtains the user's user name and password registered with an app store, and logs into the app store to search for an application by using “pdf+edit” as keywords. The system obtains a software application named YYY and maintains the login state to the app store.

At this time, the system pops up a prompt message that the pdf file cannot be edited, and then pops up a prompt message indicating that there is a software application capable of editing a pdf file in the app store.

The user views the above prompt message, and can directly access the webpage for the software application YYY in the app store. Since the user has logged into the app store, he/she can now download and install the software application YYY.

Alternatively, if the user does not view the webpage for the software application YYY in the app store, he/she can log out from the app store.

### Example 3

The current application state of the terminal is monitored. When the user access a webpage written in French, the system learns that the current user-configured language is Chinese, while the accessed webpage is in French. Instead of popping up a prompt message indicating that the webpage cannot be translated (i.e., a detectable state change incurring no prompt occurs), the system automatically intercepts this prompt message, and obtains a current state that a webpage cannot be translated. The system obtains keywords “Chinese”, “French” and “translation”, obtains the user's user name and password registered with an app store, and logs into the app store to search for an application by using “Chinese +French +translation” as keywords. The system obtains a translation software application and maintains the login state to the app store.

At this time, the system pops up a prompt message that the webpage cannot be translated, and also pops up a prompt message indicating that there is a translation software application capable of translating the webpage in the app store.

The user views the above prompt message and can directly enter the webpage for the translation software application in the app store. Since the user has logged into the app store, he/she can now download and install the translation software application.

Alternatively, if the user does not view the webpage for the translation software application in the app store, he/she can log out from the app store.

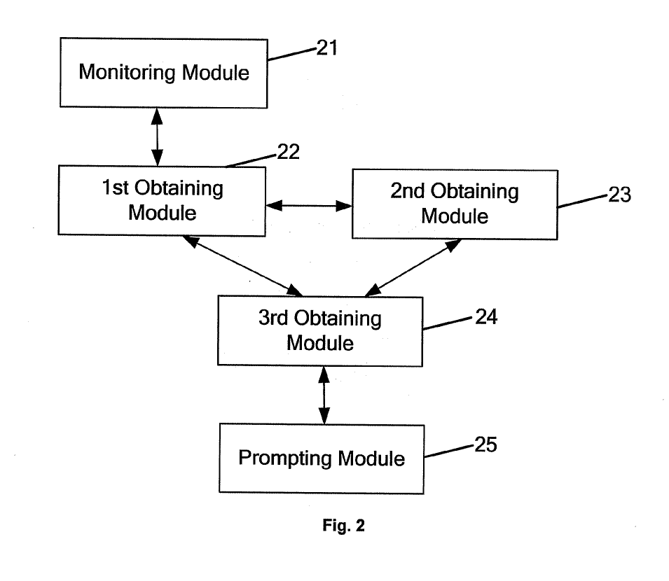

FIG. 2 is a block diagram showing the structure of a terminal according to an embodiment of the present invention. As shown in FIG. 2, the terminal includes the following modules.

A monitoring module 21 is configured to monitor a current state of the terminal.

A first obtaining module 22 is configured to obtain state description information for the current state when the current state satisfies a predetermined condition.

A second obtaining module 23 is configured to obtain address information for a set of applications.

A third obtaining module 24 is configured to obtain a search result by searching the set of applications corresponding to the address information for an application corresponding to the current state based on the state description information.

A prompting module 25 is configured to present a prompt message indicative of the search result in the terminal.

The terminal can further include a memory module (not shown) configured to store the set of applications. The memory module may be connected with the second obtaining module 23.

The terminal may further include a search module (not shown) connected with the memory module and the third obtaining module 24, and configured to search the set of applications in the memory module for the application corresponding to the current state based on the state description information, thereby determining the search result.

The terminal may further include a communication module (not shown) configured to send the state description information to a server connected with the terminal and receive the search result from the server. The set of applications is stored in the server, and the server is configured to search the set of applications for the application corresponding to the current state based on the state description information and return the search result to the terminal.

Here, the current state includes one of a current operation state of an operating system of the terminal, and a current state of an application running in the terminal.

Here, the current state satisfying the predetermined condition includes one of: a state change incurring pop-up of a prompt message occurring in the operating system, a detectable state change not incurring pop-up of a prompt message occurring in the operating system, a state change incurring pop-up of a prompt message occurring in an application running in the terminal, and a detectable state change occurring in an application running in the terminal.

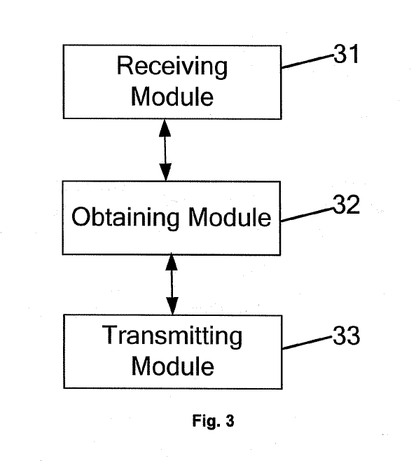

FIG. 3 is a block diagram showing the structure of a server according to an embodiment of the present invention. The server may be accessed by a terminal. As shown in FIG. 3, the server includes the following modules.

A receiving module 31 is configured to receive state description information from a terminal. The state description information corresponds to a current state of the terminal, and is obtained when the current state is monitored to be satisfy a predetermined condition.

An obtaining module 32 is configured to obtain a search result by searching for an application corresponding to the current state based on the state description information.

A transmitting module 33 is configured to send the search result to the terminal such that the terminal presents a prompt message indicative of the search result.

FIG. 2 and FIG. 3 show the terminal and the app store corresponding to the above discussed method, respectively. The operation processes and principles of the terminal and the app store have been described above in connection with the method and the description thereof will be omitted here. Reference can be made to the respective parts of the method.

In summary, with the above solutions of the present invention, a user's operation scenario and use state are automatically captured and by the operating system of the terminal the application associated with the current use scenario is automatically recommended, as a solution, from various categories in an application store based on requirements of the scenario, such that the user can directly acquire the application. In this way, the user may access the software application that can exactly satisfy his/her requirements in a more quickly manner. With the present invention, the user can search a large number of software applications in an app store for the desired application quickly and accurately, thereby solving the problem in the prior art that the user has to spend a long time on searching a software application manually and cannot determine whether the found software application can solve the problem that occurs in use of the terminal.

While the preferred embodiments of the present invention have been described above, the present invention is not limited to these embodiments. Any modifications, equivalents and improvements made without departing from the spirit and principle of the present invention are to be encompassed by the scope of the present invention.

What is claimed is:

1. A method for presenting a prompt message in a terminal, comprising:
monitoring a current state of the terminal;
obtaining state description information for the current state when the current state satisfies a predetermined condition;
obtaining address information for a set of applications;
obtaining a search result by searching the set of applications corresponding to the address information for an application corresponding to the current state based on the state description information; and
presenting a prompt message indicative of the search result in the terminal.

2. The method of claim 1, wherein the current state comprises one of a current operation state of an operating system of the terminal, and a current state of an application which is running in the terminal.

3. The method of claim 1, wherein that the current state satisfies the predetermined condition comprises one of: a state change incurring pop-up of a prompt message occurs in the operating system, a detectable state change not incurring pop-up of a prompt message occurs in the operating system, a state change incurring pop-up of a prompt message occurs in an application running in the terminal, and a detectable state change occurs in an application running in the terminal.

4. The method of claim 1, wherein the address information for the set of applications comprises at least one of an address of the set of the applications in a memory unit of the terminal, and an address of the set of applications in a server connected with the terminal.

5. The method of claim 4, wherein the address of the set of applications in the server connected with the terminal comprises an address of the set of applications in an application store connected with the terminal.

6. A terminal, comprising:
a monitoring module configured to monitor a current state of the terminal;
a first obtaining module configured to obtain state description information for the current state when the current state satisfies a predetermined condition;
a second obtaining module configured to obtain address information for a set of applications;
a third obtaining module configured to obtain a search result by searching the set of applications corresponding to the address information for an application corresponding to the current state based on the state description information; and
a prompting module configured to present a prompt message indicative of the search result in the terminal.

7. The terminal of claim 6, wherein the current state comprises one of a current operation state of an operating system of the terminal, and a current state of an application which is running in the terminal.

8. The terminal of claim 6, wherein that the current state satisfies the predetermined condition comprises one of: a state change incurring pop-up of a prompt message occurs in the operating system, a detectable state change not incurring pop-up of a prompt message occurs in the operating system, a state change incurring pop-up of a prompt message occurs in an application running in the terminal, and a detectable state change occurs in an application running in the terminal.

9. The terminal of claim 6, further comprising:
a memory module configured to store the set of applications.

10. The terminal of claim 9, further comprising:
a search module configured to search the set of applications in the memory module for the application corresponding to the current state based on the state description information, thereby determining the search result.

11. The terminal of claim 6, further comprising:
a communication module configured to send the state description information to a server connected with the terminal and receive the search result from the server,
wherein the set of applications is stored in the server and the server is configured to search the set of applications for the application corresponding to the current state based on the state description information, thereby determining the search result.

12. A server, comprising:
a receiving module configured to receive state description information from a terminal, the state description information corresponding to a current state of the terminal, and being obtained when the current state is monitored to be satisfy a predetermined condition;
an obtaining module configured to obtain a search result by searching for an application corresponding to the current state based on the state description information; and
a transmitting module configured to send the search result to the terminal such that the terminal presents a prompt message indicative of the search result.
